(19) United States
(12) Patent Application Publication
(10) Pub. No.: US 2026/0210844 A1
(43) Pub. Date: Jul. 23, 2026

(54) SPECTRUM MEASUREMENT SYSTEM

(71) Applicant: LIVESTRONG OPTOELECTRONICS CO., LTD., KAOHSIUNG CITY (TW)

(72) Inventor: Tzu-Huan CHENG, KAOHSIUNG CITY (TW)

(21) Appl. No.: 19/028,040

(22) Filed: Jan. 17, 2025

(51) Int. Cl. G01N 21/31

(52) U.S. Cl. CPC G01N 21/31; G01N 2201/103

(57) ABSTRACT

A spectrum measurement system for detecting a sample including a light source of broad wavelength and a spectrometer is disclosed. The light source of broad wavelength is adapted to provide a light with a wide wavelength range to irradiate the sample and generate a reflected light and a transmitted light on the sample. The spectrometer is adapted to receive spectral signals of the reflected light and the transmitted light of the sample at the same time, and directly calculate an absorption spectrum for the sample.

### BACKGROUND

### Technical Field

The present invention is related to a spectral measurement device, and more particularly to a spectrum measurement system for the muti-functional measurement of absorption, reflection, and transmission spectra of a sample.

### Description of Related Art

In the current technology, microspectroscopy measurement systems have been widely used in various fields, including semiconductor detection, biomedical analysis, and material science research. However, there are still many problems, such as insufficient measurement accuracy, limited wavelength range, low system stability, and inconvenient operation. Especially when measuring tiny samples or complex samples, it is usually difficult to achieve high sensitivity and high resolution at the same time. In addition, some systems lack the function of performing multi-measurement of transmission, reflection, or absorption spectra, which requires a manual switch process or additional adjustments, and also cannot provide precise alignment.

Many of the current microspectroscopy measurement systems have light sources with a limited wavelength range and cannot cover broad spectral ranges such as ultraviolet, visible, and infrared light. This will cause limitations in analysis results for applications that require multi-band analysis, such as analysis of surface or internal characteristic of materials.

Conventional microscopic optical systems usually utilize a light of large beam size to target tiny samples, thereby resulting in insufficient spectral resolution and the inability to accurately measure small areas of the tiny samples. Therefore, it is a big challenge to the applications that require the analysis of micron-scale samples, especially for biological samples or semiconductor materials.

In the current technology, the transmission efficiency of the transmitted or reflected light signal is low. Also, the signal may be decreased during the transmission process, resulting in distortion of the final spectral data and directly affecting the accuracy and reliability of the measurement.

In the current technology, the measuring modes of the reflection/transmission spectrum usually need to be switched manually, which makes the operation inconvenient and easily introduces operational errors. It is especially more inconvenient in a measurement environment that requires rapid and multiple switching.

From the problems mentioned above, the conventional spectral measurement systems cannot meet the demand for high-resolution spectral measurement of tiny samples, nor can they achieve rapid automatic switching of multiple bands. Therefore, it is an object of the present invention to provide a spectral measurement system designed to provide a wider wavelength range, higher focusing accuracy, and smarter automatic switching functions to respond to the needs of spectral analysis in various applications.

### BRIEF SUMMARY OF THE INVENTION

Therefore, one object of the present invention is to provide a spectrum measurement system that can overcome the shortcomings of the existing technology which includes a light source with a wide wavelength range and can perform high-precision measurement of penetration, reflection, and absorption spectrums on samples. The spectrum measurement system for detecting a sample according to the present invention includes a light source of broad wavelength, adapted to provide a light with a wide wavelength range to irradiate the sample and generate a reflected light and a transmitted light on the sample; and a spectrometer adapted to receive spectral signals of the reflected light and the transmitted light of the sample at the same time, and directly calculate an absorption spectrum for the sample.

According to an embodiment of the present invention, the wavelength of the light source is between 190 nm and 5000 nm.

According to an embodiment of the present invention, wherein the spectrometer includes a high-resolution and is capable of analyzing optical signals from the ultraviolet to the near infrared, with a wavelength range from 190 nm to 5000 nm.

Another object of the present invention is to provide a spectrum measurement system for measuring a sample, the spectrum measurement system includes a light source of broad wavelength adapted to provide light with a wide wavelength range to irradiate the sample and generate a reflected light and a transmitted light on the sample; a first focusing optical module adapted to focus the light from the light source or to focus the reflected light; a second focusing optical module adapted to focus the transmitted light; a first optical switch module adapted to control an opening and closing of transmission of the reflected light; a second optical switch module adapted to control an opening and closing of the transmission of the transmitted light; and a spectrometer adapted to receive and analyze the spectral signal of the reflected light and/or the transmitted light.

According to an embodiment of the present invention, wherein the first focusing optical module and the second focusing optical module include a high numerical aperture microscopic objective lens.

According to an embodiment of the present invention, wherein the first optical switch module and the second optical switch module are selectively turned on or off to measure the reflected light, or the transmitted light, or to measure both the reflected light and the transmitted light simultaneously.

According to an embodiment of the present invention, wherein the spectrum measurement system further comprises a two-dimensional scanning platform mechanism adapted to scan and measure a specific area of the sample.

According to an embodiment of the present invention, wherein the spectrum measurement system further comprises an image capture module to observe positions of light spots on the sample.

According to an embodiment of the present invention, wherein the spectrum measurement system further comprises Raman Spectroscopy and/or Fluorescence Spectroscopy.

### BRIEF DESCRIPTION OF THE DRAWINGS

FIG. 1 is a schematic diagram of a spectrum measurement system according to an embodiment according to the present invention;

FIG. 2 is a functional block diagram of a spectrum measurement system according to a preferred embodiment according to the present invention;

FIG. 3 is a configuration diagram of a spectrum measurement system according to another preferred embodiment according to the present invention; and

FIG. 4, is a schematic diagram of a spectrum measurement system according to still another embodiment according to the present invention.

### DETAILED DESCRIPTION OF THE INVENTION

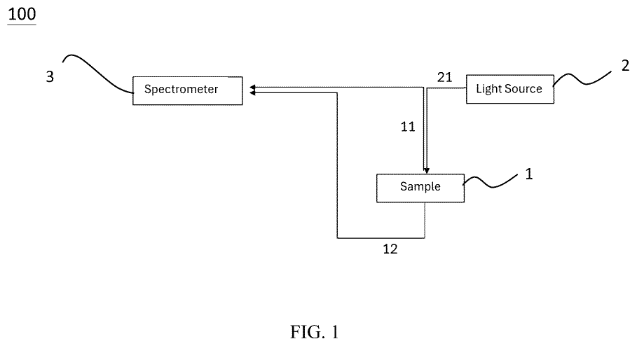

FIG. 1 is a schematic diagram of a spectrum measurement system according to an embodiment according to the present invention. As shown in FIG. 1, the spectrum measurement system 100 is adapted to measure an absorption spectrum of a sample 1 and mainly includes a light source 2 and a spectrometer 3. The light source 2 is adapted to emit light 21 to irradiate the sample 1. Then, a reflected light 11 and a transmitted light 12 from the sample 1 are coupled into the spectrometer 3. According to the present invention, the spectrum measurement system 100 is adapted to directly detect the absorption spectrum of the sample 1 by simultaneously coupling the reflected light 11 and the transmitted light 12 of the sample 1 into the spectrometer 3, wherein the sample 1 is made of semiconductor materials, such as silicon or germanium semiconductor wafers or other semiconductor materials, but the present invention is not limited thereto.

According to one embodiment of the present invention, the spectrum measurement system includes a light source, a focusing optical module, an optical switch module, and a spectrometer. The light source is a broadband light source and is adapted to generate light in a wide wavelength range, including ultraviolet light, visible light, and infrared light, and is capable of testing optical characteristics of a variety of different materials. The focusing optical module of the spectrum measurement system is adapted to focus the light emitted by the light source on the surface or inside of the sample to form a tiny beam to provide high-precision spectral measurement of small areas of the sample. The optical switch module is adapted to selectively switch and control the optical signals of the transmitted light, the reflected light, or the absorption light of the sample to be coupled into the spectrometer for analysis. The spectrometer is adapted to receive and analyze the optical signal emitted by the sample and can measure the transmittance, reflectance, and absorption spectrum to provide high-precision and high-resolution spectral data.

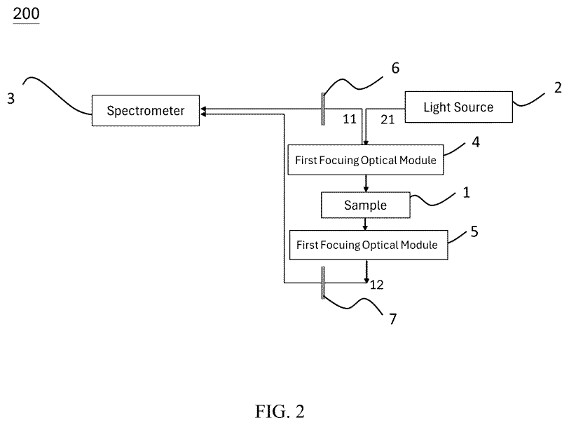

FIG. 2 is a functional block diagram of a spectrum measurement system according to a preferred embodiment according to the present invention. The spectrum measurement system 200 for measuring a sample 1 includes a light source 2 and a spectrometer 3, a first focusing optical module 4, a second focusing optical module 5, a first optical switch module 6, and a second optical switch module 7. The spectrum measurement system 200 is adapted to detect a transmission spectrum, a reflection spectrum, or an absorption spectrum of the sample 1. The sample 1 is made of semiconductor materials, such as silicon or germanium semiconductor wafers, or other semiconductor materials, but the present invention is not limited to thereto.

The first focusing optical module 4 can focus the light 21 from the light source 2 into a tiny beam of light to irradiate the sample 1. After irradiating the sample 1, the first focusing optical module 4 and the second focusing optical module 5 can respectively collect the reflected light 11 and the transmitted light 12 of the sample 1. Then, the reflected light 11 and the transmitted light 12 being collected are directed to the spectrometer 3. The first optical switch module 6 is positioned between the spectrometer 3 and the first focusing optical module 4, and the second optical switch module 7 is positioned between the spectrometer 3 and the second focusing optical module 5. By turning on the first optical switch module 6 and turning off the second optical switch module 7, a spectrum of the reflected light 11 can be measured through the spectrometer 3, while by turning off the first optical switch module 6 and turning on the second optical switch module 7, a spectrum of the transmitted light 12 can be measured by the spectrometer 3. On the other hand, by turning on both the first optical switch module 6 and the second optical switch module 7, an absorption spectrum of the sample 1 can be measured through the spectrometer 3. Then, by comparing the spectra of different wavelength ranges, it is able to obtain the information of the quality or defect information of the sample 1.

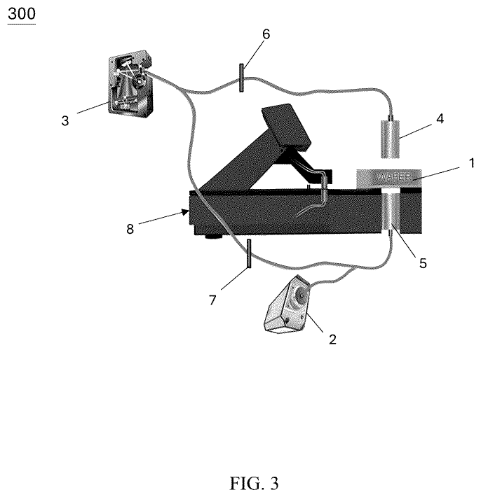

FIG. 3 is a configuration diagram of a spectrum measurement system according to another preferred embodiment according to the present invention. The spectrum measurement system 300 is adapted to measure the sample 1 and includes a light source 2 and a spectrometer 3, a first focusing optical module 4, a second focusing optical module. 5, a first optical switch module 6, and a second optical switch module 7. The first focusing optical module 4 and the second focusing optical module 5 are adapted to collect reflected light and transmitted light from the sample 1 respectively. Then, the reflected light and the transmitted light being collected are coupled into the spectrometer 3. In this embodiment, the first focusing optical module 4, the second focusing optical module 5, the first optical switch module 6, the second optical switch module 7, and the spectrometer 3 are all connected via optical fibers 30.

The light source 2 can be, for example, a xenon lamp, a halogen lamp, an LED light source, or a light bulb, but the present invention is not limited thereto. For example, the wavelength of the light source 2 can be between 190 nm and 5000 nm but is not limited thereto.

The spectrometer 3 can be a single spectrometer or a combination of plural spectrometers, and the wavelength of the spectrometer 3 can be between 190 nm and 5000 nm but is not limited thereto. According to one embodiment of the present invention, the spectrometer includes a high-resolution analysis range, including optical signals in the ultraviolet to near-infrared range.

The first focusing optical module 4 and the second focusing optical module 5 can be, for example, a group of lenses, a group of reflecting mirrors, a fiber collimating lens, an objective lens, a microstructure lens, a metalens, a light guide, an integrating sphere or a combination thereof. According to one embodiment of the present invention, the first focusing optical module 4 and the second focusing optical module 5 include a high numerical aperture microscopic objective lens capable of focusing the light into micron-level light spots to improve the sensitivity of spectral measurement.

According to the spectrum measurement system 300 shown in FIG. 3, the light 21 emitted by the light source 2 passes through the first focusing optical module 4 to form a very small spot, which irradiates the sample 1. According to different measurement requirements, the transmitted light 12 or reflected light 11 is transmitted to the spectrometer 3 through the optical fiber 30 for analysis. The first optical switch module 6 and the second optical switch module 7 are responsible for switching between different measurement modes, i.e., transmission mode, reflection mode, or absorption mode.

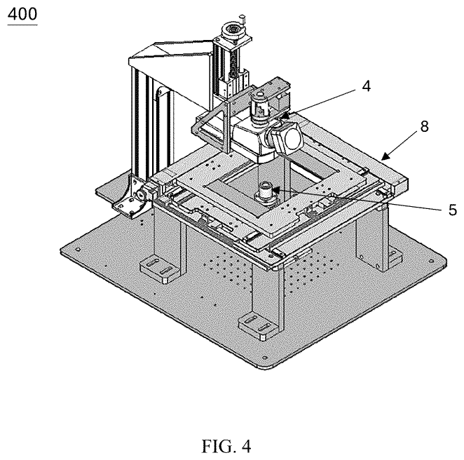

FIG. 4, is a schematic diagram of a spectrum measurement system according to still another embodiment according to the present invention. As shown in FIG. 4, the spectrum measurement system 400 has the same structure as the the spectrum measurement system 300 of FIG. 3 and further includes a two-dimensional scanning platform mechanism 8 for scanning and measuring a specific area of the sample. In more detail, the two-dimensional scanning platform mechanism 8 can be utilized to perform X-Y scanning to calculate the spectral difference between each of the measurement points and can use an analysis algorithm to generate corresponding numerical indicators, for drawing a two-dimensional distribution map. The spectrum measurement system 400 can further include an image capture module to observe the position of light spots on the sample 1. Since the characteristic of the spectrum is related to the purity, doping impurity concentration, dopant type, defects, and junction characteristics, etc. of the sample 1, the analysis of the material quality of the sample 1 can be obtained by the spectrum measurement system 400. In addition, the spectrum measurement system 400 can measure the reflection spectrum, transmission spectrum, and absorption spectrum at the same position of the sample. The spectrum measurement system 400 also can be applied to micro-defect detection and film thickness analysis of materials or wafers.

Furthermore, the spectrum measurement system according to the present invention can further integrate spectral technologies including Raman Spectroscopy or Fluorescence Spectroscopy to improve the accuracy and diversity of spectral analysis.

From the description mentioned above, the spectrum measurement system according to the present invention can be applied to detect a single point or a specific area of the sample 1. In addition, by utilizing an automatic program control, when the sample 1 is to be tested under different conditions, there is no need to manually remove and reinstall the sample 1 or reset the measurement parameters. Therefore, the spectrum measurement system according to the present invention is very convenient for operation and therefore the measurement speed thereof can be improved. Therefore, the spectrum measurement system according to the present invention has the advantages of fast measurement speed and high efficiency and is a very practical and multi-functional detection device.

The spectrum measurement system according to the present invention has a simple structure, easy operation, high stability, and flexibility, and can be used to study the spectral characteristics of a variety of materials and samples.

The present invention has been described in terms of particular embodiments found or proposed by the inventor to comprise preferred methods for the practice of the present invention. It will be appreciated by those skilled in the art that, in light of the present disclosure, numerous modifications and changes can be made in the particular embodiments exemplified without departing from the intended scope of the invention. Moreover, due to biological functional equivalency considerations, changes can be made in methods, structures, and compounds without affecting the biological action in kind or amount. All such modifications are intended to be included within the scope of the appended claims.

What is claimed is:

1. A spectrum measurement system for detecting a sample, comprising:
a light source of broad wavelength, adapted to provide a light with a wide wavelength range to irradiate the sample and generate a reflected light and a transmitted light on the sample; and
a spectrometer adapted to receive spectral signals of the reflected light and the transmitted light of the sample at the same time, and directly calculate an absorption spectrum of the sample.

2. The spectrum measurement system of claim 1, wherein the wavelength of the light source is between 190 nm and 5000 nm.

3. The spectrum measurement system of claim 1, wherein the spectrometer includes a high-resolution and is capable of analyzing optical signals from the ultraviolet to the near infrared, with a wavelength range from 190 nm to 5000 nm.

4. A spectrum measurement system for measuring a sample, including:
a light source of broad wavelength adapted to provide light with a wide wavelength range to irradiate the sample and generate a reflected light and a transmitted light on the sample;
a first focusing optical module adapted to focus the light from the light source or to focus the reflected light;
a second focusing optical module adapted to focus the transmitted light;
a first optical switch module adapted to control an opening and closing of transmission of the reflected light;
a second optical switch module adapted to control an opening and closing of the transmission of the transmitted light; and
a spectrometer adapted to receive and analyze the spectral signal of the reflected light and/or the transmitted light.

5. The spectrum measurement system of claim 4, wherein the first focusing optical module and the second focusing optical module include a high numerical aperture microscopic objective lens.

6. The spectrum measurement system of claim 4, wherein the wavelength of the light source is between 190 nm and 5000 nm.

7. The spectrum measurement system of claim 6, wherein the first optical switch module and the second optical switch module are selectively turned on or off to measure the reflected light, or the transmitted light, or to measure both the reflected light and the transmitted light simultaneously.

8. The spectrum measurement system of claim 7, wherein the spectrometer includes a high-resolution and is capable of analyzing optical signals from the ultraviolet to the near infrared, with a wavelength range from 190 nm to 5000 nm.

9. The spectrum measurement system of claim 7, wherein the spectrum measurement system further comprises a two-dimensional scanning platform mechanism adapted to scan and measure a specific area of the sample.

10. The spectrum measurement system of claim 7, wherein the spectrum measurement system further comprises an image capture module to observe position of light spots on the sample.

11. The spectrum measurement system of claim 7, wherein the spectrum measurement system further comprises Raman Spectroscopy and/or Fluorescence Spectroscopy.
